(19) United States
(12) Patent Application Publication
(10) Pub. No.: US 2007/0286580 A1
(43) Pub. Date: Dec. 13, 2007

(54) Method of and apparatus for recording MPEG program streams, apparatus for reproducing MPEG program streams, and information storage medium

(75) Inventor: Hiroyuki Kamio, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/714,224

(22) Filed: Mar. 6, 2007

(30) Foreign Application Priority Data
Mar. 31, 2006 (JP) 2006-097542

(51) Int. Cl. H04N 5/91

(52) U.S. Cl. 386/96

(57) ABSTRACT

Of the content recorded in the HD DVD-VR standard, when program_mux_rate indicates that there is MPEG2-PS whose transfer rate used in the encoding in the content recorded in the HD DVD-VR standard is 10.08 Mbps or less, the MPEG2-PS is copied at high speed to an optical disk complying with the DVD-VR standard without re-encoding at a rate equal to or higher than the transfer rate (e.g., 4.6 Mbps) used in the original encoding.

### CROSS-REFERENCE TO RELATED APPLICATIONS

This application is based upon and claims the benefit of priority from Japanese Patent Application No. 2006-097542, field Mar. 31, 2006, the entire contents of which are incorporated herein by reference.

### BACKGROUND

1. Field

One embodiment of the invention relates to a method of and apparatus for recording MPEG program streams (such as MPEG2-PS) at any one of a plurality of maximum transfer rates, and an information storage medium. More particularly, this invention relates to the technique for copying or dubbing to a low-rate (DVD-VR) medium (such as an optical disk or a hard disk) at high speed (or by increasing the rate without re-encoding and then copying the content as it is) MPEG-PS video objects (VOB) whose maximum bit rate can be covered by a low rate standard (DVD-VR) in the content recorded in a high-rate standard (HD DVD-VR), even if they have been recorded in the high rate standard (HD DVD-VR), in a video recorder compatible with both of the low rate standard whose maximum bit rate is relatively low (e.g., the DVD-VR standard whose maximum rate is 10.08 Mbps) and a high rate standard whose maximum bit rate is relatively high (e.g., the HD DVD-VR standard whose maximum rate is 30.24 Mbps).

2. Description of the Related Art

Presently, digital recorders conforming to the DVD video recording (DVD-VR) standard have been widely used as video devices which record and reproduce such content as TV-broadcast programs in the NTSC-level image quality. With the start of high-definition digital broadcasting, the spread of digital recorders complying with the high-definition DVD video recording (HD DVD-VR) standard is about to begin in the field of video devices for recording and reproducing the content of digital broadcast programs in a high-resolution image quality.

It is expected that many of the high-definition DVD video recorders to be developed and popularized in the near future will be configured to be capable of recording and reproducing on the basis of not only the HD DVD-VR standard using a blue-violet laser (405 nm) but also the conventional DVD-VR standard using a red laser (650 nm). Although recording and reproducing in the both standards can be done not only on optical disks but also on hard disks, flash memories, and the like, optical disks are generally considered to be mainly used in recording and reproducing.

Since optical disks (HD DVD-R/RW/RAM) used in recording and reproducing in the HD DVD-VR standard using a blue-violet laser (405 nm) differ from optical disks (DVD-R/RW/RAM) used in recording and reproducing in the conventional DVD-VR standard using a red laser (650 nm), contents based on the HD DVD-VR standard cannot be recorded onto an optical disk (DVD-R/RW/RAM) complying with the DVD-VR standard. The HD DVD-VR standard supports not only the stream recording of MPEG2-TS in digital broadcasting but also the recording and reproducing of MPEG2-PS. Therefore, if a mechanism that copies content recorded in the HD DVD-VR standard (e.g., on a hard disk) as it is without re-encoding onto a DVD-VR optical disk for MPEG2-PS recording and reproducing (in this case, high-speed copying or high-speed dubbing can be done) can be provided, this improves the convenience of users.

The technique related to the above mechanism has been disclosed in, for example, Jpn. Pat. Appln. KOKAI Publication No. 2004-253052. In Jpn. Pat. Appln. KOKAI Publication No. 2004-253052, the data rate of an object to be recorded is checked when the hard disk drive (HDD) is written to. Then, when copying is done from the HDD to a DVD disk, if, for example, 20 Mbps is not exceeded, the data is copied as it is on the basis of the data rate checked at the time of recording to the HDD, and if the data rate is 20 Mbps or more, the data is temporarily decoded into an analog video signal, which is then re-encoded at 20 Mbps or less of data for recording. By doing this, video information differing in bit rate can be stored with less image deterioration on a DVD medium.

When what has been disclosed in Jpn. Pat. Appln. KOKAI Publication No. 2004-253052 is applied to the conventional DVD-VR standard (where the maximum bit rate permitted in the standard is 10.08 Mbps), it goes as follows. When the high-definition recording title stored in the HDD is dubbed to an information storage medium complying with the conventional DVD-DR standard, if the maximum bit rate in an object in the title has exceeded 10.08 Mbps, the violation of the DVD-VR standard is avoided by re-encoding. The maximum bit rate of the re-encoded object is recorded in management information.

Jpn. Pat. Appln. KOKAI Publication No. 2004-253052 has not revealed under what conditions high-speed copying (or high-speed dubbing) without re-encoding can be realized in copying a high-definition recording title to a conventional DVD-VR information storage medium.

An object of the present invention is to provide a mechanism that copies contents recorded in an upper-level standard (e.g., HD DVD-VR standard) without re-encoding to an information storage medium (e.g., optical disk) complying with a lower-level standard (e.g., DVD-VR standard) for MPEG2-PS recording and reproducing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B, 1C, 1D, 1E, 1F, 1G, and 1H are diagrams to help explain a data structure according to an embodiment of the present invention;

FIG. 2 is a diagram to help explain a file structure according to the embodiment;

FIG. 3 is a diagram to help explain a structure of management information (HDVR_MG) according to the embodiment;

FIG. 4 is a table to help explain an example of information stored in M_AVFITI (Movie AV File Information Table Information) included in the management information (HDVR_MG/M_AVFIT) of FIG. 3;

FIG. 5 is a table to help explain an example of information stored in each piece of M_VOB_STI (Movie VOB Stream Information) included in the management information (HDVR_MG/M_AVFIT) of FIG. 3;

FIG. 6 is a diagram to help explain an example of information stored in video attribute information (V_ATR) included in M_VOB_STI of FIG. 5;

FIG. 7 is a diagram to help explain an example of information stored in first audio attribute information (A_ATR0) included in M_VOB_STI of FIG. 5;

FIG. 8 is a diagram to help explain an example of information stored in second audio attribute information (A_ATR1) included in M_VOB_STI of FIG. 5;

FIG. 9 is a diagram to help explain a pack structure of a data unit constituting a VR object in FIG. 1F;

FIG. 10 is a table to help explain an example of information included in the pack header of FIG. 9;

FIG. 11 is a table to help explain an example of information (in the case of MPEG1, MPEG2 or MPEG4-AVC) included in the header of a video packet present as a part of the pack of FIG. 9;

FIG. 12 is a table to help explain another example of information (in the case of VC-1) included in the header of a video packet present as a part of the pack of FIG. 9;

FIG. 13 is a diagram to help explain an example of the structure of an RDI pack (RDI_PCK) placed at the head of a data unit constituting a VR object of FIG. 1F;

FIG. 14 is a table to help explain an example of information included in the system header of an RDI pack of FIG. 13;

FIG. 15 is a block diagram showing an example of the configuration of a recording and reproducing apparatus (HD DVD recorder) according to the embodiment;

FIG. 16 is a flowchart to help explain an example of the operation of the recording and reproducing apparatus (HD DVD recorder) according to the embodiment;

FIG. 17 is a diagram to help explain an example of information stored in M_VOBI (Movie Video Object Information) included in the management information (HDVR_MG/M_AVFIT/M_AVFI) of FIG. 3;

FIG. 18 is a table to help explain an example of information stored in M_VOB_GI (Movie Video Object General Information) included in M_VOBI of FIG. 17; and

FIG. 19 is a diagram to help explain an example of information stored in VOB_TY (Video Object Type) included in M_VOB_GI of FIG. 18.

### DETAILED DESCRIPTION

Various embodiments according to the invention will be described hereinafter with reference to the accompanying drawings. In general, according to one embodiment of the invention, in a method of, when a program stream obtained by encoding audio-video content according to a first digital recording standard where the maximum transfer rate is limited to a first specific value or less or a second digital recording standard where the maximum transfer rate is limited to a value equal to or smaller than a second specific value larger than the first specific value includes specific information related to at least one of the maximum transfer rate and the second digital recording standard, recording the program stream to an information storage medium capable of recording and reproducing in the first digital recording standard, a recording method comprises, when the specific information indicates that there is a program stream whose transfer rate used in the encoding is the first specific value or less in the audio-video content recorded in the second digital recording standard, writing the program stream whose transfer rate is the first specific value or less to the information storage medium without re-encoding at a rate higher than the transfer rate used in the original encoding.

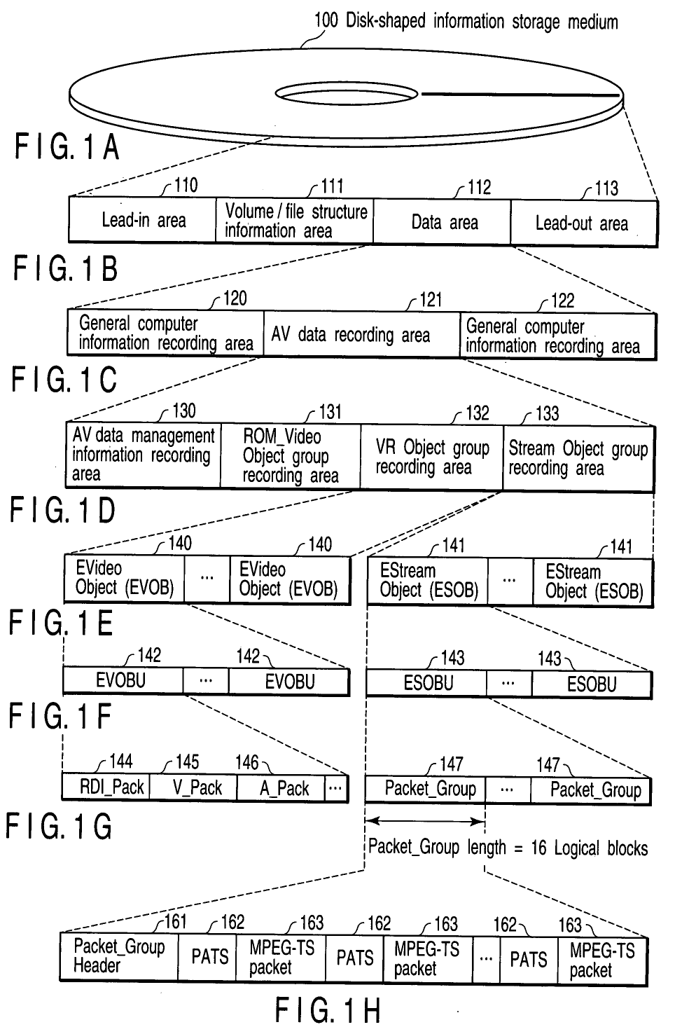

Hereinafter, referring to the accompanying drawings, embodiments of the present invention will be explained. FIGS. 1A, 1B, 1C, 1D, 1E, 1F, 1G, and 1H are diagrams to help explain a data structure according to an embodiment of the present invention. A typical example of a recordable or rewritable information storage medium is a DVD (such as a single-recording-layer or a multiple-recording-layer DVD-R, DVD-RW, or DVD-RAM using a red laser with a wavelength of about 650 nm or a blue-violet or blue laser with a wavelength of 405 nm or less) 100. As shown in FIG. 1B, the disk 100 is configured to include a volume/file structure information area 111 in which a file system is and a data area 112 in which data files are actually recorded. The file system is composed of information that indicates where which files have been recorded.

The data area 112 includes areas 120, 122 to which a general computer records data and an area 121 to which audio-video data (AV data) is recorded. The AV data recording area 121 is composed of an AV data management information area 130 in which a video manager file (VMG or HDVR_MG) for managing AV data exists, a ROM_Video object group recording area 131 to which files of object data conforming to the DVD-Video (ROM Video) standard are recorded, a VR object group recording area 132 to which files (VRO files) of object data (ESOBS: Extended Video Object Set) conforming to the video recording (VR) standard are recorded, and a recording area 133 to which stream object data (ESOBS: Extended Stream Object Set) files (SRO files) to which objects corresponding to digital broadcasting have been recorded. A recording standard for SRO files is referred to as a stream recording (SR) standard as needed.

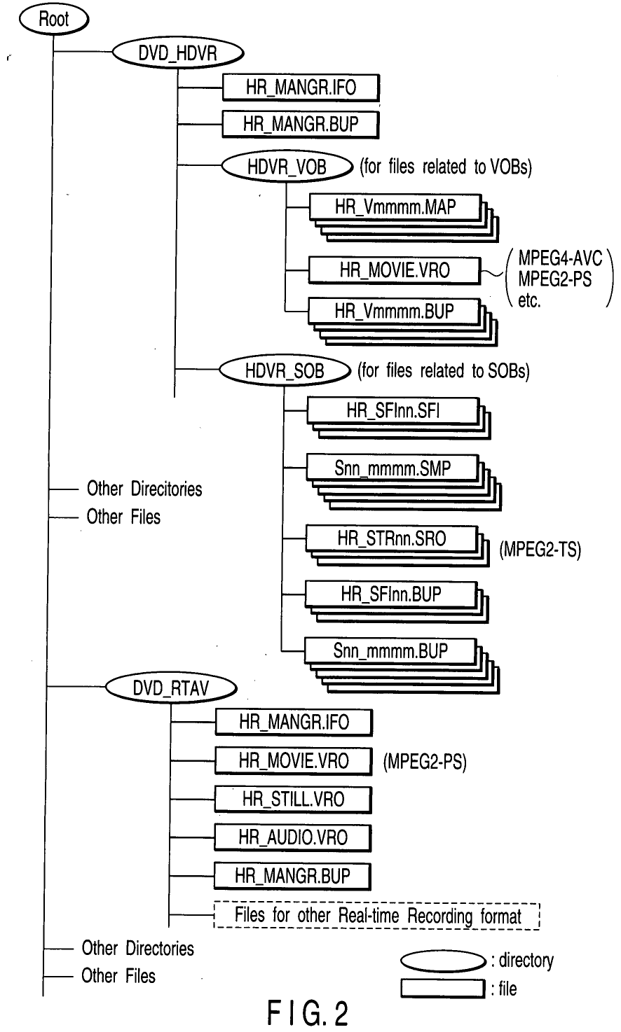

FIG. 2 is a diagram to help explain a file structure according to the embodiment. As shown in FIG. 2, a DVD_HDVR directory is composed of an HD DVD-VR format management information file HR_MANGER.IFO, an HDVR_VOB directory including a VRO file (EVOB file permitted to have a maximum rate of up to 30.24 Mbps) which is an object file of analog video input, and an HDVR_SOB directory including a digital broadcasting compatible SRO file (ESOB file). A DVD_RTAV directory under the same root directory as that of the DVD_HDVR directory is composed of a DVD-VR format management information file VR_MANGER.IFO and a VRO file (conventional DVD-VR VOB file whose maximum rate is suppressed to 10.08 Mbps) which is an object file of analog-video input.

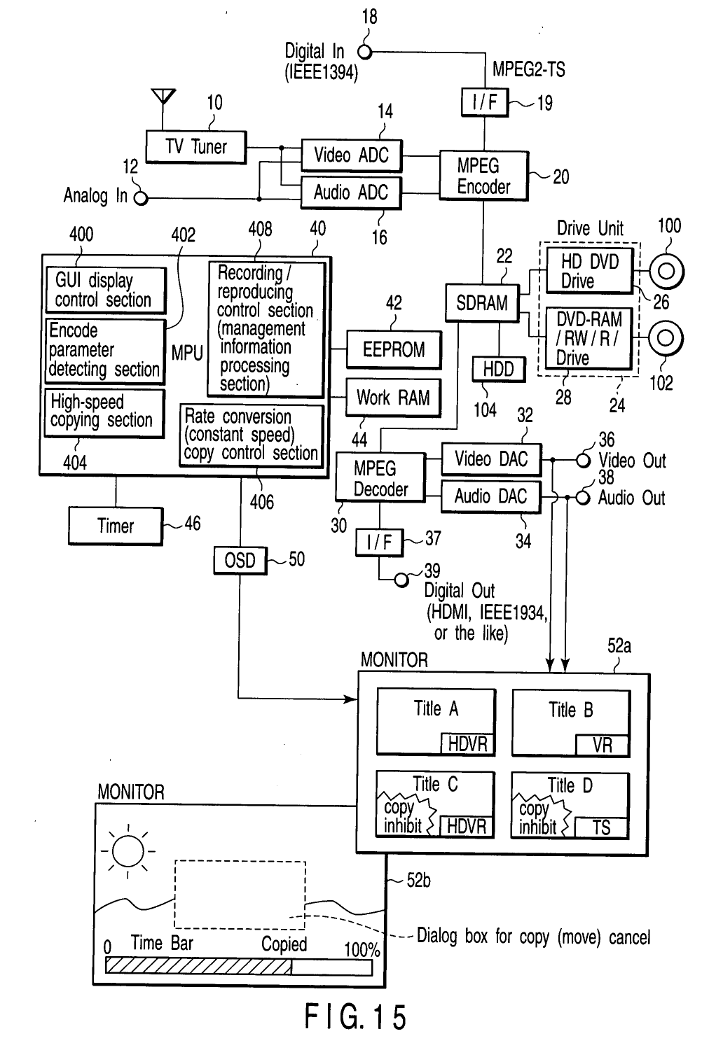

Specifically, in the file structure of the embodiment, HDVR MPEG2-TS data files, HDVR MPEG2-PS data files, and VR MPEG2-PS data files are managed under the same root directory. For example, shortcut files linked with HR_MOVIE.VRO are used as title thumbnails A, C, shortcut files linked with VR_MOVIE.VRO are used as title thumbnail B, and shortcut files linked with HR_STRnn.SRO are used as title thumbnail D, these title thumbnails A to D can be displayed on the same menu screen (refer to a representation on the monitor screen 52a of FIG. 15). This enables the user to manipulate separate objects (objects in which MPEG2-PS and MPEG2-TS are mixed) on the same screen operation environment from the menu.

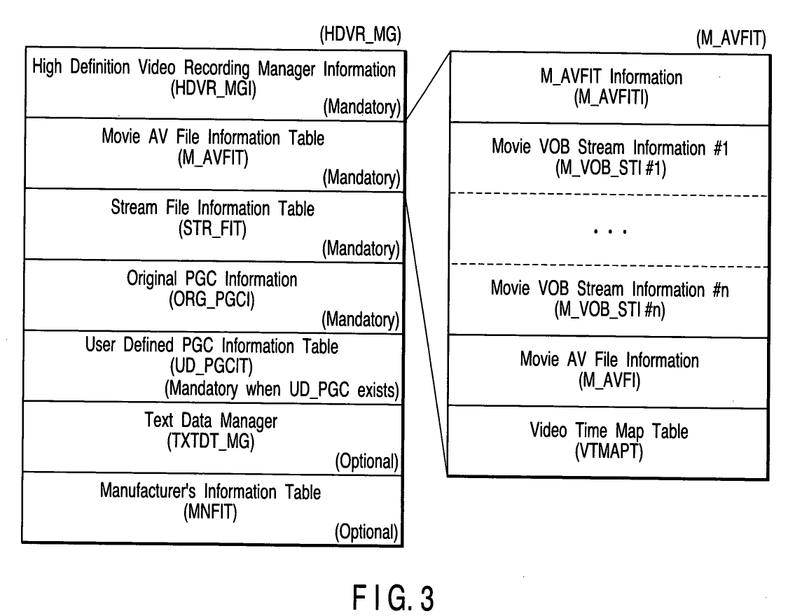

FIG. 3 is a diagram to help explain an example of the configuration of management information (HDVR_MG) according to the embodiment. The HDVR_MG file of management information is composed of a high-definition video recording manager (HDVR_MGI), a movie AV file information table (M_AVFIT), a stream file information table (STR_FIT), original program chain information (ORG_PGCI), a user definition program chain information table (UD_PGCIT), a text data manager (TXTDT_MG), and a manufacturer information table (MNFIT) in that order from its beginning. MPEG2-TS objects (SRO files) are managed on the basis of the STR_FIT and MPEG2-PS objects (VRO files) are managed on the basis of the M_AVFIT.

The M_AVFIT is composed of a movie AV file information table (M_AVFITI), one or more pieces of movie video object stream information (M_VOB_STI#1 to M_VOB_STI#n), movie AV file information (M_AVFI), and a video time map table (VTMAPT) in that order from its beginning. Here, M_AVFIT in the conventional DVD-VR standard does not include VTMAPT. Therefore, even if the object is of the same MPEG2-PS, it is possible to determine whether the MPEG2-PS conforms to the conventional DVD-VR standard or the HD DVD-VR standard, depending on whether M_AVFIT includes VTMAPT in its management information (making a determination at the management information level, not at the object information level).

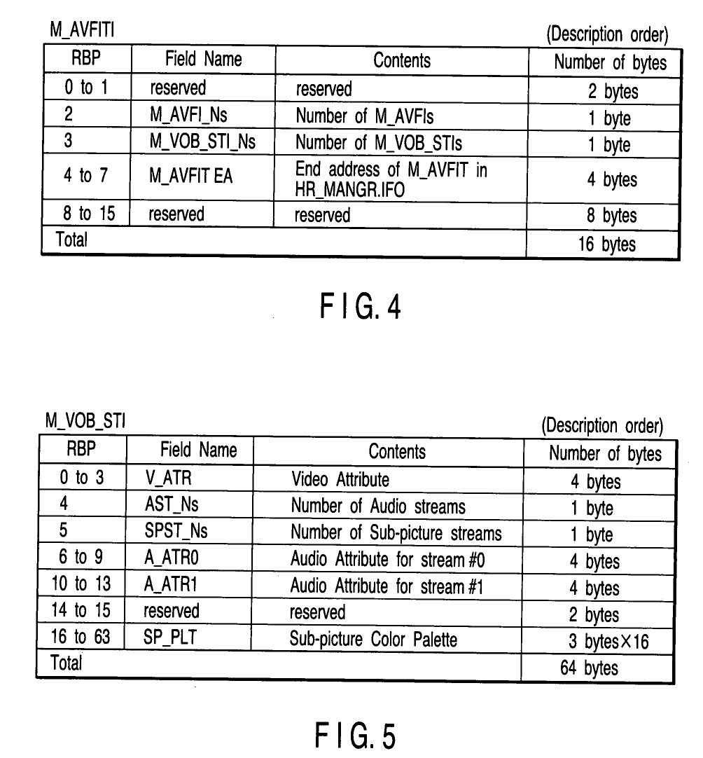

FIG. 4 is a table to help explain an example of information stored in M_AVFITI (Movie AV File Information Table Information) included in the management information (HDVR_MG/M_AVFIT) of FIG. 3. M_AVFITI is composed of information (M_AVFI_Ns) indicating how many pieces of M_AVFI there are, information (M_VOB_STI_Ns) indicating how many pieces of M_VOB_STI there are, and information on the end address of M_AVFIT in HR_MANGR.IFO (FIG. 2).

FIG. 5 is a table to help explain an example of information stored in each piece of M_VOB_STI (Movie VOB Stream Information) included in the management information (HDVR_MG/M_AVFIT) of FIG. 3. M_VOB_STI is composed of video attribute information (V_ATR), information (AST_Ns) indicating how many audio streams there are, information (SPST_Ns) indicating how many sub-picture streams there are, audio attribute information (A_ATR0) on stream #0, audio attribute information (A_ATR1) on stream #1, and color pallet information (SP_PLT) on sub-pictures.

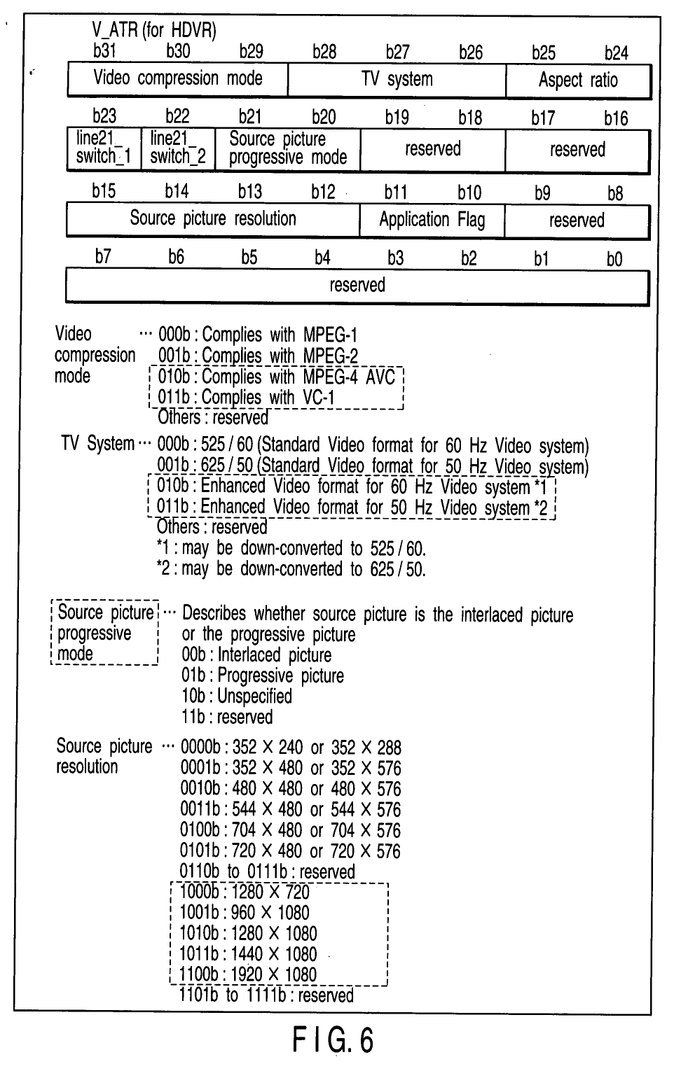

FIG. 6 is a diagram to help explain an example of information stored in video attribute information (V_ATR) included in M_VOB_STI of FIG. 5. This example of information includes information that does not exist in the DVD-VR standard, but exists only in the HD DVD-VR standard. V_ATR is composed of video compression mode information (Video compression mode), TV system information (TV system), aspect ratio information (Aspect ratio), line 21 switching information (line21_switch_1, line21_switch_2), information on source picture progressive mode (Source picture progressive mode), information on source picture resolution (Source picture resolution), and application flag information (Application Flag).

Here, in the HD DVD-VR standard, the video compression mode may include information (010b) indicating MPEG4-AVC or information (011b) indicating VC-1. Since both MPEG4-AVC and VC-1 are video compression modes that the DVD-VR standard doesn't have, even if the object is of the same MPEG2-PS, it is possible to determine whether the MPEG2-PS conforms to the conventional DVD-VR standard or the HD DVD-VR standard, depending on whether Video compression mode includes information indicating MPEG4-AVC or VC-1 (making a determination at the management information level, not at the object information level).

Moreover, the HD DVD-VR standard can include information (010b) indicating that TV system is in a 60-Hz video system extended video format (that can be down-converted to the NTSC format) or information (011b) indicating that TV system is in a 50-Hz video system extended video format (that can be down-converted to the PAL format). Since neither the 60-Hz video system extended video format nor 50-Hz video system extended video format exists in the DVD-VR standard, even if an object is the same MPEG2-PS object, it is possible to determine whether the MPEG2-PS conforms to the conventional DVD-VR standard or the HD DVD-VR standard, depending on whether the TV system includes the 60-Hz/50-Hz video system extended video format (010b or 011b) (making a determination at the management information level, not at the object information level).

In addition, the HD DVD-VR standard can include Source picture progressive mode (information indicating whether Source picture is an interlaced image or a progressive image). Since Source picture progressive mode doesn't exist in the DVD-VR standard, even if an object is the same MPEG2-PS object, it is possible to determine whether the MPEG2-PS conforms to the conventional DVD-VR standard or the HD DVD-VR standard, depending on whether information indicating Source picture progressive mode is included (making a determination at the management information level, not at the object information level).

Furthermore, the HD DVD-VR standard can include information (1000b to 1100b) indicating whether Source picture resolution is either high-definition or high-resolution (1280×720 to 1920×1080). Since neither information on high definition nor information on high resolution (1280×720 to 1920×1080) exists in the DVD-VR standard, even if an object is the same MPEG2-PS object, it is possible to determine whether the MPEG2-PS conforms to the conventional DVD-VR standard or the HD DVD-VR standard, depending on whether Source picture resolution includes information indicating either high definition or high resolution (making a determination at the management information level, not at the object information level).

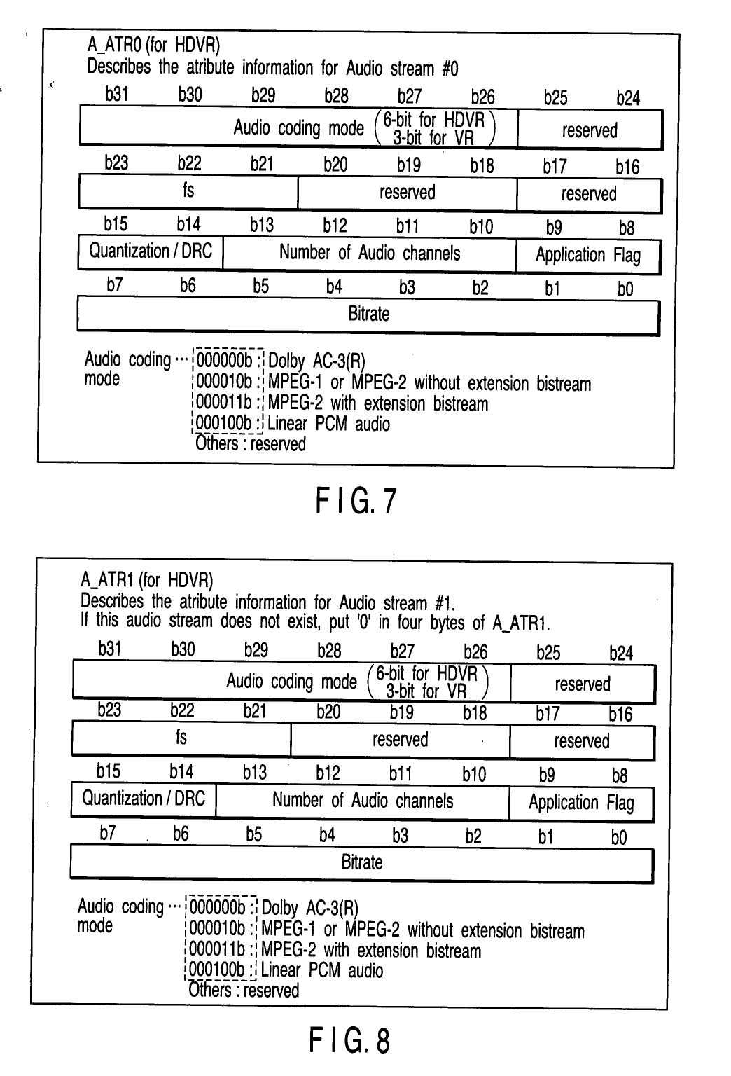

FIG. 7 is a diagram to help explain an example of information stored in first audio attribute information (A_ATR0) included in M_VOB_STI of FIG. 5. The example of information includes information that does not exist in the DVD-VR standard, but exists only in the HD DVD-VR standard. A_ATR0 is composed of audio coding mode information (Audio coding mode), sampling frequency information (fs), quantization/dynamic range control information (Quantization/DRC), information on the numbers of audio channels (Number of Audio channels), an application flag information (Application Flag), and bit rate information (Bitrate) in that order, starting at b31 to b0. When Application Flag is 00b, this means that the audio stream includes audio data in the channel mode determined by Number of Audio channels. When Application Flag is 01b, this means that the audio stream includes audio data in the multichannel mode, monaural mode, dual monaural mode, or stereo mode.

In the HD DVD-VR standard, six bits are allocated to describe Audio coding mode. In the DVD-VR standard, Audio coding mode is written in three bits. Therefore, even if an object is the same MPEG2-PS object, it is possible to determine whether the MPEG2-PS conforms to the conventional DVD-VR standard or the HD DVD-VR standard, depending on how many bits are allocated to describe Audio coding mode in A_ATR0 (making a determination at the management information level, not at the object information level).

FIG. 8 is a diagram to help explain an example of information stored in second audio attribute information (A_ATR1) included in M_VOB_STI of FIG. 5. The example of information includes information that does not exist in the DVD-VR standard, but exists only in the HD DVD-VR standard. Like A_ATR0, A_ATR1 is composed of audio coding mode information (Audio coding mode), sampling frequency information (fs), quantization/dynamic range control information (Quantization/DRC), information on the numbers of audio channels (Number of Audio channels), an application flag (Application Flag), and bit rate information (Bitrate) in that order, starting at b31 to b0.

In the HD DVD-VR standard, six bits are allocated to describe Audio coding mode. In the DVD-VR standard, Audio coding mode is written in three bits. Therefore, even if an object is the same MPEG2-PS object, it is possible to determine whether the MPEG2-PS conforms to the conventional DVD-VR standard or the HD DVD-VR standard, depending on how many bits are allocated to describe Audio coding mode in A_ATR1 (making determination at the management information level, not at the object information level).

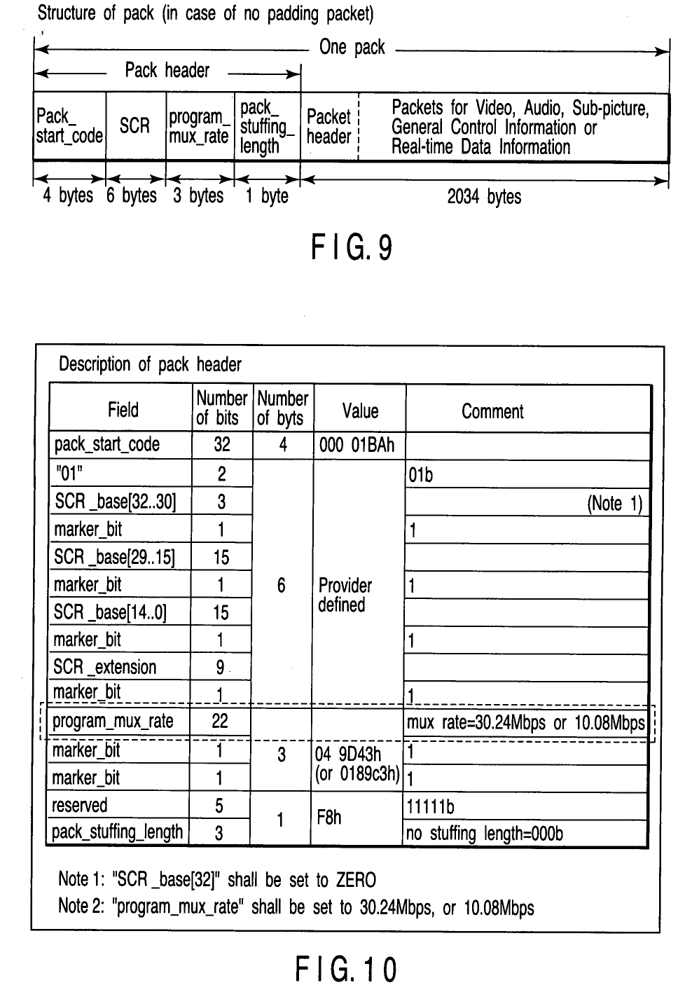

FIG. 9 is a diagram to help explain a pack structure of a data unit (EVOBU) constituting a VR object in FIG. 1F. For example, EVOBU of FIG. 1F includes not only an RDI pack at the beginning but also various packs (including a video pack, an audio pack, a sub-picture pack, and general control information packs). The structure of each pack is as shown in FIG. 9. In the Pack header, program_mux_rate is included.

FIG. 10 is a table to help explain an example of information included in Pack header of FIG. 9. The example of information includes information that does not exist in the DVD-VR standard, but exists only in the HD DVD-VR standard (that is, program_mux_rate including a high bit rate of 30.24 Mbps permitted in the HD DVD-VR standard). When MPEG2-PS is encoded at a rate of 10.08 Mbps or less in the HD DVD-VR standard, “0189C3” representing 10.08 Mbps is written in program_mux_rate in the header of a pack including the MPEG2-PS stream information.

On the other hand, when MPEG2-PS is encoded at a rate of larger than 10.08 Mbps in the HD DVD-VR standard, “049D43h” representing 30.24 Mbps is written in program_mux_rate in the header of a pack including the MPEG2-PS stream information. From the description in the “program_mux_rate,” it is possible to determine whether the MPEG2-PS is compatible with the DVD-VR standard in the range of the HD DVD-VR standard (“0189C3” representing program_mux_rate=10.08 Mbps) or is in the HD DVD-VR standard (“049D43h” representing program_mux_rate=30.24 Mbps) (making a determination at the object information level, not at the management information level).

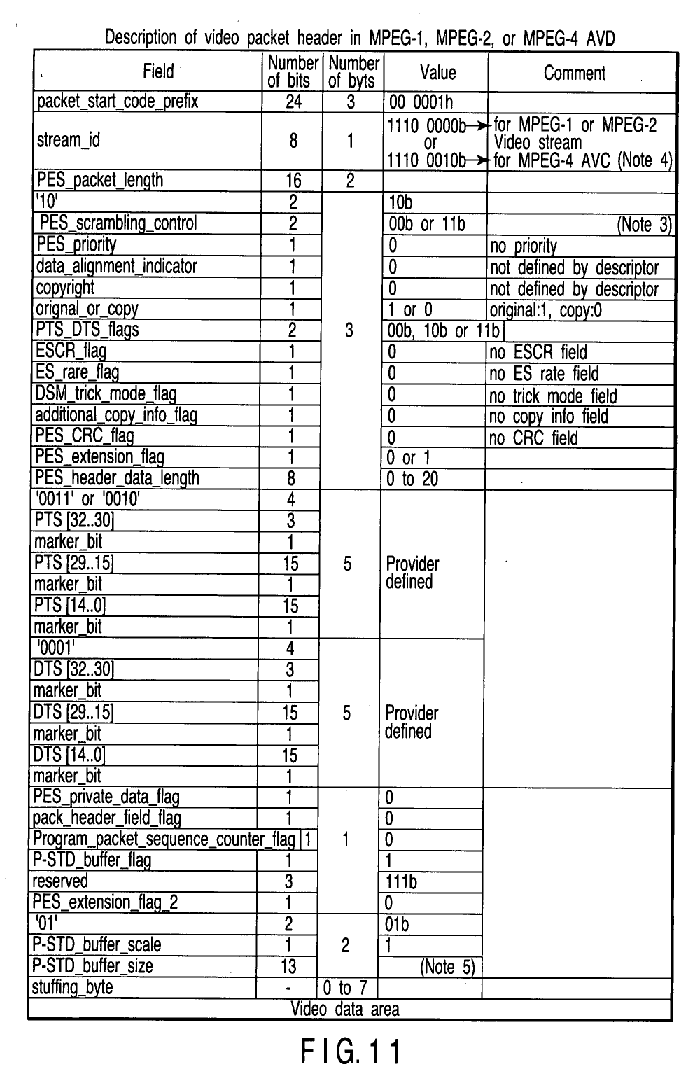

FIG. 11 is a table to help explain an example of information (in the case of MPEG1, MPEG2 or MPEG4-AVC) included in the header of a video packet present as a part of the pack of FIG. 9. The example of information includes information that does not exist in the DVD-VR standard, but exists only in the HD DVD-VR standard. The MPEG1, MPEG2, or MPEG4-AVC video packet header includes stream_id, PES_scrambling_control, P-STD_buffer_size, and other information.

In the HD DVD-VR standard, PES_scrambling_control includes information indicating whether the corresponding pack is an encrypted pack (Encrypted Pack). Therefore, even if an object is the same MPEG2-PS object, it is possible to determine whether the MPEG2-PS is compatible with the DVD-VR standard in the range of the HD DVD-VR standard or is in the HD DVD-VR standard, depending on the presence or absence of information indicating whether the pack is Encrypted Pack (making a determination at the object information level, not at the management information level).

Moreover, in the HD DVD-VR standard, information indicating whether it is MPEG4-AVC can be written in stream_id. Therefore, even if an object is the same MPEG2-PS object, it is possible to determine whether the MPEG2-PS is compatible with the DVD-VR standard in the range of the HD DVD-VR standard or is in the HD DVD-VR standard, depending on whether stream_id includes the description of MPEG4-AVC (making a determination at the object information level, not at the management information level).

Furthermore, in the HD DVD-VR standard, a buffer size (946176 bytes in standard and 1851392 bytes in extension) can be written in P-STD_buffer_size. Therefore, even if an object is the same MPEG2-PS object, it is possible to determine whether the MPEG2-PS is compatible with the DVD-VR standard in the range of the HD DVD-VR standard or is in the HD DVD-VR standard, depending on whether P-STD_buffer_size includes the description of a buffer size for MPEG4-AVC (making a determination at the object information level, not at the management information level).

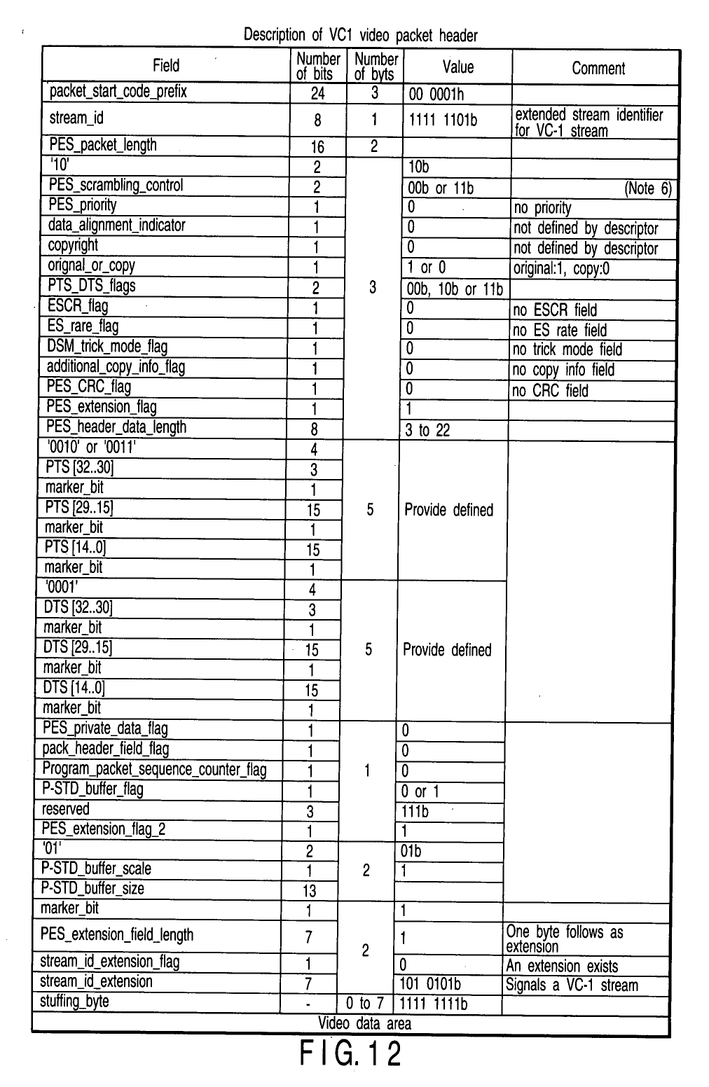

FIG. 12 is a table to help explain another example of information (in the case of VC-1) included in the header of a video packet present as a part of the pack of FIG. 9. The example of information includes information that does not exist in the DVD-VR standard, but exists only in the HD DVD-VR standard. The VC-1 video packet header includes stream_id, PES_scrambling_control, P-STD_buffer_size, and other information.

In the HD DVD-VR standard, even in the case of VC-1, PES_scrambling_control includes information indicating whether the corresponding pack is an encrypted pack (Encrypted Pack). Therefore, even if an object is the same MPEG2-PS object, it is possible to determine whether the MPEG2-PS is compatible with the DVD-VR standard in the range of the HD DVD-VR standard or is in the HD DVD-VR standard, depending on the presence or absence of information indicating whether it is Encrypted Pack (making a determination at the object information level, not at the management information level).

Moreover, in the HD DVD-VR standard, information indicating whether it is VC-1 can be written in stream_id. Therefore, even if an object is the same MPEG2-PS object, it is possible to determine whether the MPEG2-PS is compatible with the DVD-VR standard in the range of the HD DVD-VR standard or is in the HD DVD-VR standard, depending on whether stream_id includes the description of VC-1 (making a determination at the object information level, not at the management information level).

Furthermore, in the HD DVD-VR standard, even in the case of VC-1, a buffer size (946176 bytes in standard and 1851392 bytes in extension) can be written in P-STD_buffer_size. Therefore, even if an object is the same MPEG2-PS object, it is possible to determine whether the MPEG2-PS is compatible with the DVD-VR standard in the range of the HD DVD-VR standard or is in the HD DVD-VR standard, depending on whether P-STD_buffer_size includes the description of a buffer size for VC-1 (making a determination at the object information level, not at the management information level).

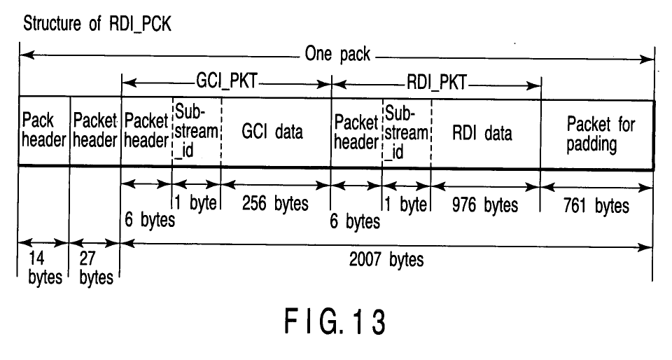

FIG. 13 is a diagram to help explain an example of the structure of an RDI pack (RDI_PCK) placed at the head of a data unit constituting a VR object of FIG. 1F. For example, in each EVOBU of FIG. 1F, an RDI pack is placed at the head. The PDI pack is composed of a pack header, a system header, a General Control Information packet (GCI_PKT), a Real-time Data Information packet (RDI_PKT), and a padding packet at the end as needed.

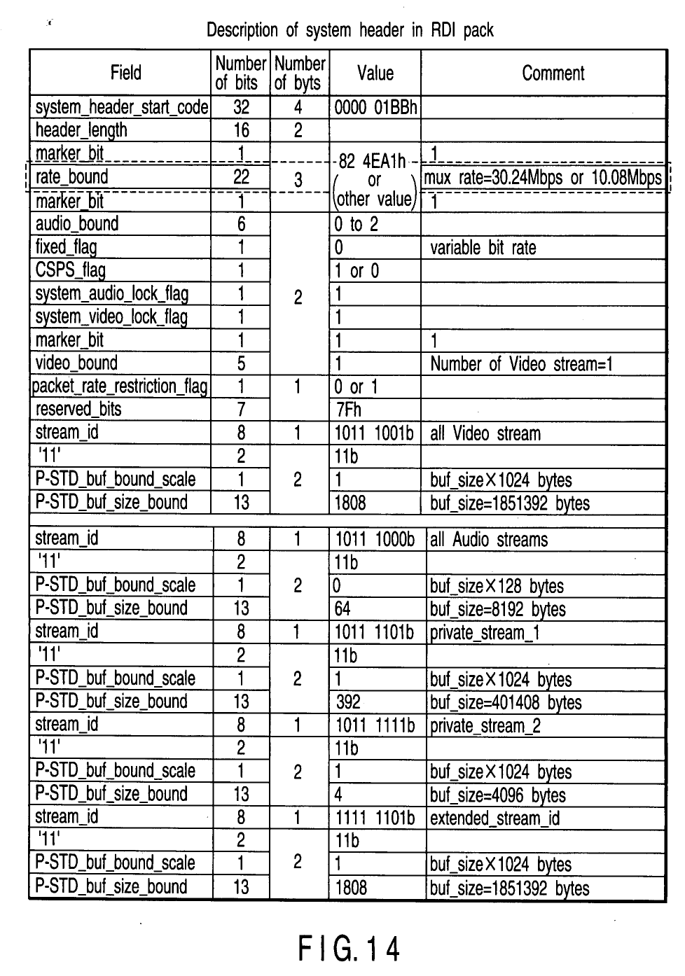

FIG. 14 is a table to help explain an example of information included in the system header of the RDI pack of FIG. 13. The example of information includes information that does not exist in the DVD-VR standard, but exists only in the HD DVD-VR standard. The RDI pack is composed of rate_bound that indicates either mux_rate=30.24 Mbps, the upper limit in the HD DVD-VR standard or mux_rate=10.08 Mbps conforming to the DVD-VR standard in the range of the HD DVD-VR standard. From the description of the “rate_bound,” it is possible to determine whether the MPEG2-PS is compatible with the DVD-VR standard in the range of the HD DVD-VR standard or is in the HD DVD-VR standard (making a determination at the object information level, not at the management information level).

FIG. 15 is a block diagram showing an example of the configuration of a recording and reproducing apparatus (HD DVD recorder) according to an embodiment of the present invention. An analog AV output of a TV tuner 10 having the function of receiving satellite digital TV broadcasting, terrestrial digital TV broadcasting, and terrestrial analog TV broadcasting is input to a Video ADC 14 and an Audio ADC 16. An analog AV input from an external analog input terminal 12 is also input to the Video ADC 14 and Audio ADC 16. A video stream digitized at the Video ADC 14 and an audio stream digitized by the Audio ADC 16 are input to an MPEG Encoder 20. A digital stream (such as MPEG2-TS) from an external digital input terminal 18 is input via an interface 19, such as IEEE 1394 (or HDMI), to the MPEG Encoder 20. Although not shown, a digital stream (such as MPEG2-TS) from the TV tuner 10 is also input to the MPEG Encoder 20 as needed. The MPEG Encoder 20 encodes the input stream to MPEG2-PS or to MPEG4-AVC except when causing the input MPEG2-TS to pass through.

Here, cases where the input stream is encoded to MPEG2-PS include a case where the input stream is encoded to MPEG2-PS on the basis of the DVD-VR standard (with a maximum rate of 10.08 Mbps and a maximum resolution of 720×480 or 720×576), a case where the input stream is encoded to MPEG2-PS at a high rate on the basis of the HD DVD-VR standard (with a maximum rate of 30.24 Mbps and a maximum resolution of 1920×1080), and a case where the input stream is encoded to MPEG2-PS at a row rate within the limits of the HD DVD-VR standard (with a maximum rate of 10.08 Mbps and a maximum resolution of 720×480 or 720×576).

The stream data encoded (or passed through) at the MPEG Encoder 20 is buffered temporarily in a high-speed memory, such as an SDRAM (Synchronous Dynamic Random Access Memory) 22. At the SDRAM 22, the following stream rewriting processes in item 1 to item 3 are carried out as needed:

1. When Audio is Linear PCM, the value of sub_stream_id in Audio Pack is rewritten.

2. The contents of PDI-PCK are rewritten.

3. A cipher of CPRM is decrypted once and then is encrypted again to AACS or vice versa.

The stream data is buffered and processed at the SDRAM 22. According to its content, the resulting data is transferred to the HDD 104, HD DVD Drive 26, or DVD Drive 28 with specific timing. A high-capacity hard disk drive (e.g., 1 TB) is used as the HDD 104. A blue laser (e.g., with a wavelength of λ=405 nm) is used in the HD DVD Drive 26. A red laser (e.g., with a wavelength of λ=650 nm) is used in the DVD Drive 28.

The HD DVD Drive 26 and DVD Drive 28 constitute a Drive Unit 24. The Drive Unit 24 may include two independent drives with corresponding rotary drive systems, or an HD DVD/EDVD compatible drive (of the twin pickup type) which has a blue laser optical head and a red laser optical head sharing a rotary drive system, or a two-wavelength optical system (of the single pickup type) which switches between a blue laser and a red laser sharing a rotary drive system and an optical head mechanism. FIG. 15 shows a case where two independent Drive 26 and Drive 28 are used together with their respective rotary drive systems. When a blue laser is used, not only optical disks of the −R/−RW/RAM types but also optical disks of the +R/+RW type can be used as information storage media (blue-laser optical disks 100 and red-laser optical disks 102) used in those drives. The same holds true for a red laser. In the future, it will be possible to use a high-capacity optical disk making use of hologram.

The HD DVD Drive 26 corresponds to recording and reproducing on the basis of the HD DVD-VR standard. The DVD Drive 28 corresponds to recording and reproducing on the basis of the DVD-VR standard. The DVD Drive 28 is configured to be capable of recording and reproducing MPEG-PS data whose maximum rate, video attributes, and others are within the limits of the DVD-VR standard and which are encoded even on the basis of the HD DVD standard, at constant speed or high speed using a disk complying with the DVD-VR standard (such as a single-sided, single-layer DVD-R/RW/RAM, a single-sided, dual-layer DVD-R, or a double-sided, single-layer DVD-RAM). (Specifically, NTSC video MPEG2-PS data recorded in the HDD 104 at a maximum rate of 10.08 Mbps is configured to be capable of being copied or dubbed to a DVD-VR disk 102 at high speed, even if it is the data encoded on the basis of the HD DVD-VR standard. It goes without saying that MPEG2-PS data encoded on the basis of the HD DVD-VR standard can be copied or dubbed to an HD DVD-VR disk 100 at high speed).

The stream data reproduced from the HD DVD Drive 26, DVD Drive 28, and/or HDD 104 is transferred via the SDRAM 22 to an MPEG Decoder 30. The MPEG Decoder 30 has the function of decoding MPEG2-TS, MPEG2-PS, or MPEG4-AVC according to the transferred stream and other decoding functions (e.g., the function of decoding VC-1 determined in the HD DVD-VR standard). The video data (MPEG2-TS or MPEG2-PS) decoded at the MPEG decoder 30 is converted to a standard-picture-quality or high-definition-picture-quality analog video signal at a Video DAC 32. The analog-video signal is output at a Video Out terminal 36. The audio data decoded at the MPEG Decoder 30 is converted to an analog audio signal at an Audio DAC 34. The analog audio signal is output at an Audio Out terminal 38. Moreover, the decoded data is MPEG2-TS, it is sent via an interface 37, such as IEEE 1394 (or HDMI), and is output at a Digital Out terminal 39 to the outside world. The AV signals (analog video signal and analog audio signal) decoded at the MPEG Decoder 30 and D/A-converted at the DAC 32, 34 are input to an external monitor.

The operation of the recording and reproducing apparatus (HD DVD recorder) of FIG. 15 is controlled by an MPU 40. The MPU 40 is provided with an EEPROM 42 which stores firmware and various control parameters, a work RAM 44, and a timer 46. The firmware of the MPU 40 includes a GUI display control section 400 which provides a graphic user interface, an encode parameter detecting section 402, a high-speed copying (high-speed dubbing) section 404, a rate conversion copy (constant-speed copy/constant-speed dubbing) control section 406, and a recording/reproducing control section (management information processing section). The result of processing at the GUI display control section 400 is displayed on an external monitor via an on-screen display section (OSD) 50 (a display screen 52a for title thumbnails, a dialog box display screen 52b in copying, and the like can be obtained from the processing at the OSD 50).

In the embodiment of FIG. 15, an ultrahigh-capacity HDD (e.g., 1-TB HDD) or a plurality of high-capacity HDDs (e.g., 500-GB HDD+500-GB HDD) may be used as the HDD 104. The method of using the recording area of the HDD includes a method of dividing the recording area logically into a plurality of partitions and a method of specifying a use for each physical HDD. In the former method, it is conceivable that, for example, of 1 TB, 400 GB of a first partition are allocated to digital high-definition broadcasting MPEG2-TS recording (TS titles), 400 GB of a second partition are allocated to digital high-definition broadcasting MPEG4-AVC recording (HDVR titles), and 200 GB of a third partition are allocated to analog broadcasting, digital broadcasting, or external input MPEG2-PS recording (VR titles). In the latter method, it is conceivable that, for example, a first 400-GB HDD is allocated to MPEG2-TS recording (TS titles), a second 400-GB HDD is allocated to MPEG4-AVC recording (HDVR titles), and a third 200-GB HDD is allocated to MPEG2-PS recording (VR titles).

In the embodiment, the VR titles include not only MPEG2-PS recording in the existing DVD-VR standard but also MPEG2-PS whose maximum rate is suppressed to 10.08 Mbps in the next generation HD DVD standard. It is possible to determine whether the stream data in a VR title is MPEG2-PS conforming to the DVD-VR standard or MPEG2-PS whose maximum rate is suppressed to 10.08 Mbps in the HD DVD standard, depending on, for example, whether the content of “program_mux_rate” of FIG. 10 is 10.08 Mbps or 30.24 Mbps at the object data level. At the management information level, the determination can be made, depending on, for example, whether “V_ATR” of FIG. 6 includes a resolution (e.g., 1280×1080) that is impossible in the existing DVD-VR standard.

The above-described plurality of types of titles (TS title, HDVR title, and VR title) are subjected to file management in the same directory as shown in FIG. 2. Therefore, the icons or thumbnails of the plurality of titles (TS title, HDVR title, and VR title) can be displayed on the same screen 52a. Consequently, the user can operate each of the plurality of titles in the same manner, even if they have been recorded under any condition in any standard (such as HD DVD-VR or DVD-VR) (in HD DVD-VR recording at a maximum rate of 10.08 Mbps or in DVD-VR recording at a maximum rate of 10.08 Mbps).

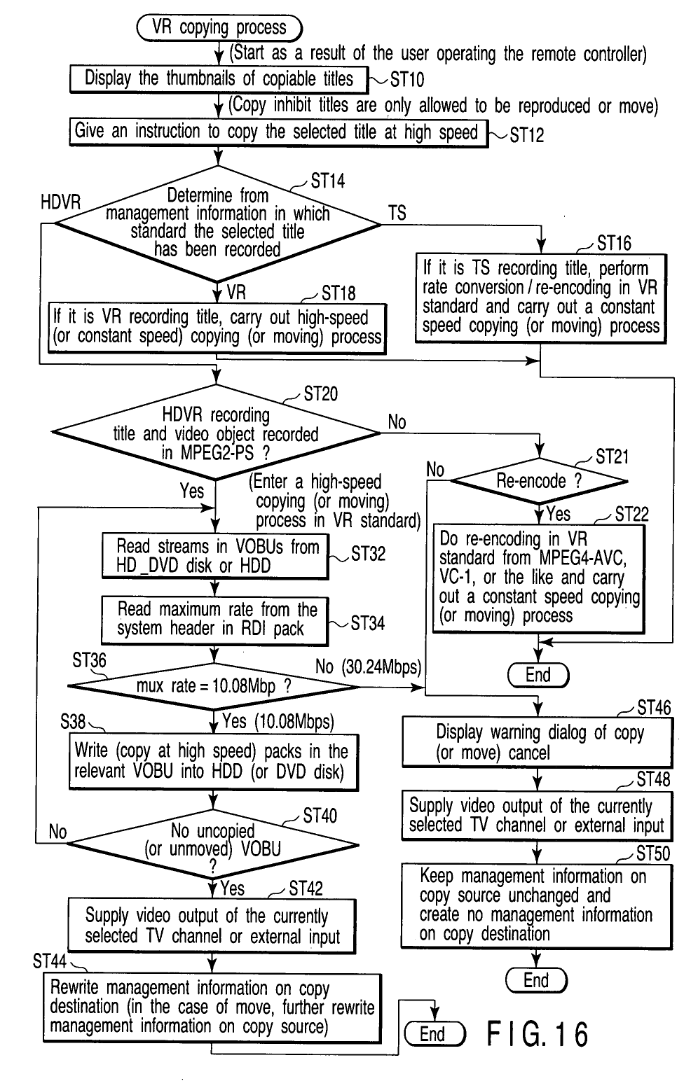

FIG. 16 is a flowchart to help explain an operation (a copying or dubbing process) in the recording and reproducing apparatus (HD DVD recorder) according to the embodiment. An explanation will be given of a case where content is copied (or dubbed) in both formats in a DVD recorder (such as the recording and reproducing apparatus of FIG. 15) capable of reading and writing AV information in both the DVD-VR format (DVD Video Recording Format) and the HD DVD-VR format (HD DVD Video Recording Format). In addition, explanation will be given with an emphasis on a case where content temporarily recorded to the HDD 104 of FIG. 15 (or a blue laser optical disk 100) is copied (or dubbed) at high speed to the optical disk 100 or 102 in a format compatible with the DVD-VR standard in reproduction.

Copying content at high speed in the DVD recorder means that copying content by basically copying data as it is, although involving data changing work, instead of decoding MPEG-compressed data and re-encoding the data. In the case of copy-once content permitted to be copied only once, management information on content (content to be copied) inhibited from being copied after a first copy (or first recording) is eliminated, thereby realizing the movement of content.

Control corresponding to the flowchart of FIG. 16 is performed by the firmware of the MPU 40 of FIG. 15. In the process of FIG. 16, when the user instructs the HDD 104 of FIG. 15 to display the recorded titles by means of a remote controller (not shown), the thumbnails of reproducible titles are displayed on the screen 52a of FIG. 15 (ST10). The screen display can include copiable titles and titles which can be reproduced and moved but are inhibited from being copied. The display screen 52a of FIG. 15 shows titles A, B as copiable titles and titles C, D as titles inhibited from being copied (only permitted to be reproduced or moved). The screen display is processed by the firmware of MPU 40 of FIG. 15 (GUI display control section 400).

MPEG2-PS data in the copy-free VR title B can be copied to the optical disk 100 or 102 at high speed, or copied to the optical disk 100 or 102 at constant speed by rate conversion, or moved to the optical disk 100 or 102. Of the MPEG2-PS data in copy-free HDVR title A, data whose maximum rate is 10.08 Mbps can be copied to the optical disk 100 or 102 at high speed, or copied to the optical disk 100 or 102 at constant speed by rate conversion, or moved to the optical disk 100 or 102. Of the MPEG2-PS data in copy-free HDVR title A, data whose maximum rate is 30.24 Mbps can be copied to the optical disk 100 or 102 at high speed, or copied to the optical disk 100 or 102 at constant speed by rate conversion, or moved to the optical disk 100 or 102.

Title C obtained by recording copy-once content before recording to the HDD 104 in the HD DVD-VR format is a copy-inhibited title. The data in the copy-inhibited HDVR title C (including not only MPEG2-PS but also MPEG4-AVC and VC1) can be neither copied at high speed nor copied by rate conversion, but can be moved to the disk 100 or 102 corresponding to a specific copy management method (such as CPRM or AACS). Moreover, title D obtained by recording copy-once content before recording to the HDD 104 in MPEG2-TS is also a copy-inhibited title. The data in the copy-inhibited TS title D can be neither copied at high speed nor copied by rate conversion, but can be moved to the disk 100 or 102 corresponding to a specific copy management method (such as CPRM or AACS) to do re-encoding.

When the user selects the thumbnail of a desired title by a cursor operation using a remote controller and gives an instruction to copy (or dub) at high speed the title selected by the key operation on the remote controller (ST12), the standard (or format) used in recording the selected title is verified from the management information (ST14). Specifically, if the selected title corresponds to a file in the HDVR_VOB directory of FIG. 2, the format of the title is determined to be HDVR (in the HD DVD-VR standard). If the selected title corresponds to a file in the HDVR_SOB directory of FIG. 2, the format of the title is determined to be TS (in the HD DVD-VR standard). If the selected title corresponds to a file in the DVD_RTAV directory of FIG. 2, the format of the title is determined to be VR (in the DVD-VR standard). The determination is made by the firmware (management information processing section 408) of the MPU 40 of FIG. 15.

If the result of the determination in ST14 has shown TS recording title, the stream is rate-converted and re-encoded to MPEG2-PS, which is copied to, for example, the optical disk 100 or 102 of FIG. 15 at constant speed or moved to the optical disk 100 or 102 at constant speed in the HD DVD-VR standard or DVD-VR standard (ST16). This is carried out by the firmware of MPU 40 of FIG. 15 (rate conversion (constant-speed) copy control section 406) (when the recording title is inhibited from being copied, only the moving process is possible).

If the result of the determination in ST14 has shown a VR recording title, the stream is copied directly to the optical disk 102 at high speed or moved directly to the optical disk in the DVD-VR standard (ST18). If the user wants to, the stream of the VR recording title may be rate-converted and re-encoded to MPEG2-PS, which is copied to, for example, the optical disk 102 of FIG. 15 at constant speed or moved to the optical disk 102 at constant speed in the DVD-VR standard (ST18). These are carried out by the firmware of MPU 40 of FIG. 15 (high-speed copying section 404 or rate conversion (constant-speed) copy control section 406).

If the result of the determination in ST14 has shown an HDVR recording title, a check is made to see if the stream data in the object is MPEG2-PS (ST30). The check can be made by looking at, for example, “Video compression mode” in the video attribute (V_ATR) of FIG. 6. The check is made by the firmware of MPU 40 of FIG. 15 (encode parameter detecting section 402).

If the stream data in the checked object is not MPEG2-PS, but MPEG4-AVC or VC-1 (NO in ST20), the user is asked whether to convert (or re-encode) the data to the DVD-VR format and copy or move the result (ST21). If the data is to be converted to the DVD-VR format and copied or moved (YES in ST21), the stream is re-encoded to MPEG2-PS in the DVD-VR standard, and then copied or moved at constant speed to, for example, the optical disk 102 of FIG. 15 in the DVD-VR standard (ST22). These are carried out by the firmware of MPU 40 of FIG. 15 (rate conversion (constant-speed) copy control section 406). If the data is not converted (or is not re-encoded) to the DVD-VR format (NO in ST21), control proceeds to the process in ST 46.

If the result of the check in S20 has shown MPEG2-PS (YES in ST20), control goes to the process of copying or moving the data at high speed in a format compatible with the DVD-VR standard in reproduction. After control enters the process, the stream data in the title to be copied (or moved) is read in video object units (VOBU; EVOBU in FIG. 1F) from the disk 100 or HDD 104 to the SDRAM 22 (ST32). When system header (see FIG. 14) has been read from the RDI pack (see FIG. 1G or FIG. 13) at the beginning of the video object unit, there is information on the maximum rate “rate_bound” in which “mux_rate=30.24 Mbps” or “mux_rate=10.08 Mbps” has been written in the system header (ST34).

If “rate_bound” shows “mux_rate=10.08 Mbps” (YES in ST36), the packs (144 to 146 of the like in FIG. 1G) in the corresponding video object are written to the HDD 104 or optical disk 102 (or disk 100) at high speed (e.g., eight-times speed) (ST38). This high-speed writing process is repeated as long as there are uncopied (or unmoved) video object units (NO in ST40).

If “rate_bound” shows “mux_rate=30.24 Mbps” (NO in ST36), MPEG2-PS in the bVD-VR format cannot be acquired without re-encoding (that is, neither high-speed copying nor high-speed moving can be done). Thus, a dialog is displayed to the effect that high-speed copying (or high-speed moving) about to be done is cancelled (see the display example 52b of FIG. 15) (ST46). In the lower part of the same screen as the dialog, the reproducing times of the object parts copied (or moved) at high speed until then are displayed in time bar form (see the display example 52b of FIG. 15). After a specific time passes, the copy cancel dialog disappears together with the time bar. Thereafter, the TV channel (the reception channel of the TV tuner 10 of FIG. 15) active at that time or the video output at an external input (AV input to the analog input terminal 12 of FIG. 15) is output at output terminals 36, 38 of FIG. 15 (ST48). Since copying or moving has been canceled without the completion of the copying or moving, the management information at the copy source (see FIG. 3 or the like) is caused to remain unchanged even if it is about moving, and the process is ended without creating management information at the copy destination (ST50).

If, with “rate_bound” being “mux_rate=10.08 Mbps” (YES in ST36), copying (or moving) is continued until the last video object has been copied (or moved) (YES in ST40), the video output of the TV channel (the reception channel of the TV tuner 10 of FIG. 15) active at that time or of an external input (an AV input to the analog input terminal 12 of FIG. 15) is output at the output terminals 36, 38 of FIG. 15 (ST42). Since copying or moving has been completed, management information is written to the copy destination and the management information at the copy source (see FIG. 3 and others) is left in the case of copying and is erased in the case of moving and then the process is ended (ST44).

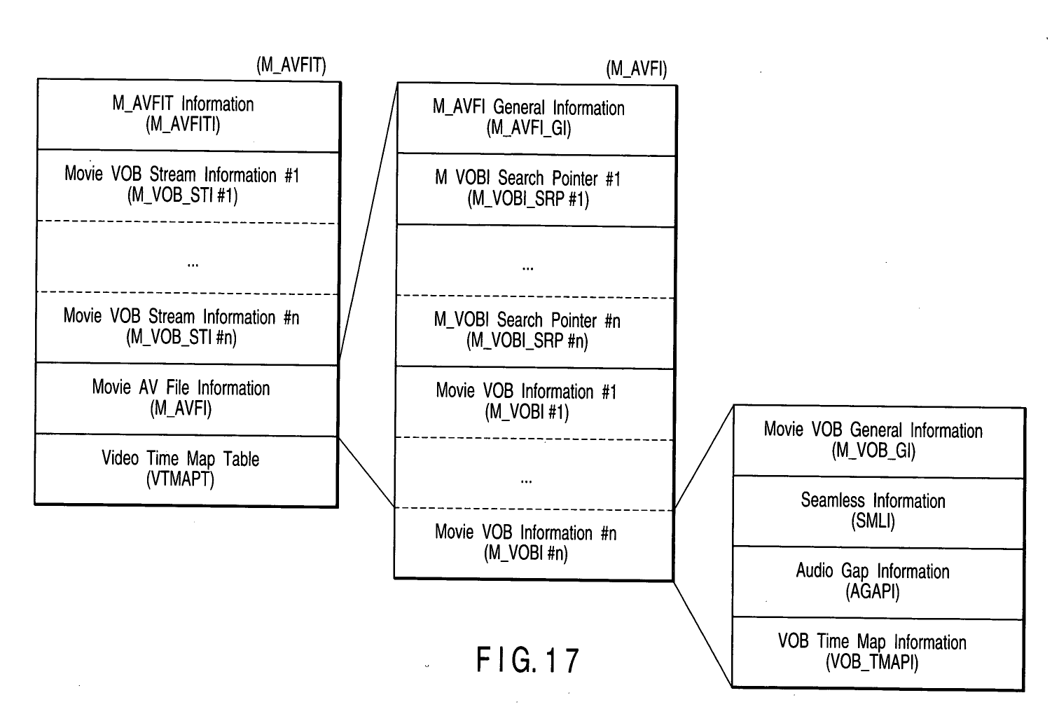

FIG. 17 is a diagram to help explain an example of information stored in M_VOBI (Movie Video Object Information) included in the management information (HDVR_MG/M_AVFIT/M_AVFI) of FIG. 3. M_VOBI is composed of M_AVFI general information (M_AVFI_GI), one or more M_VOBI#1 to M_VOBI#n, and their search pointers M_VOBI_SRP#1 to M_VOBI_SRP#n. Each M_VOBI (for example, M_VOBI#n searched for with M_VOBI_SRP#n) is composed of M_VOB general information (M_VOB_GI), seamless information (SMLI), audio gap information (AGAPI), and VOB time map information (VOB_TMAPI).

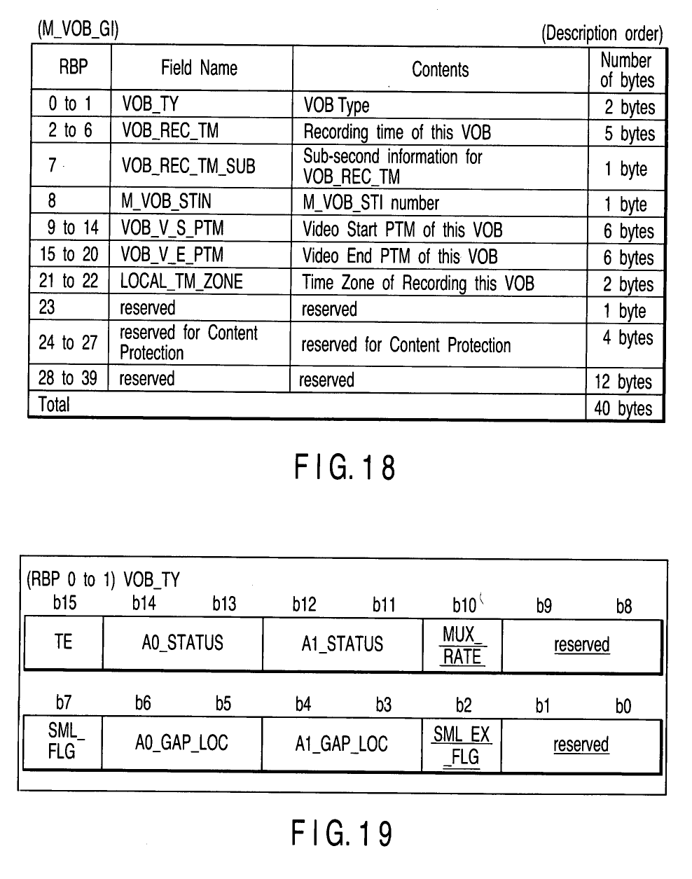

FIG. 18 is a table to help explain an example of information stored in M_VOB_GI (Movie Video Object General Information) included in M_VOBI of FIG. 17. M_VOB_GI is composed of VOB_TY in which what type of VOB the corresponding VOB is has been written, VOB_REC_TM in which the time at which when the beginning video data in the VOB was recorded has been written, VOB_REC_TM_SUB in which sub-second information on the VOB_REC_TM has been written in time units of the video system ( 1/60 second units in NTSC and 1/50 second units in PAL), M_VOB_STIN in which the stream information number of M_VOB has been written, VOB_V_S_PTM in which the reproduce start time (encoded to PTS) of a first video field (or video frame) of the corresponding VOB has been written, VOB_V_E_PTM in which the reproduce start time of the last video field (or video frame) of its VOB has been written, LOCAL_TM_ZONE in which a time zone of an area in which the original of the corresponding VOB has been recorded has been written, and an area in which information to protect the contents of recording (to protect copyright or copy control) is to be written.

FIG. 19 is a diagram to help explain an example of information stored in VOB_TY (Video Object Type) included in M_VOB_GI of FIG. 18. VOB_TY is composed of TE, AO_STASUS, A1_STASUS, MUX_RATE, SML_FLG, AO_GAP_LOC, A1_GAP_LOC, and SML_EX_FLG. In TE, a provisional erase flag indicating whether the corresponding VOB is in a provisional erase state is written. In AO_STATUS, whether Audio stream #0 recorded as an original audio stream when the VOB was created has been modified is written. Written in A1_STATUS is whether Audio stream #1 recorded as an original audio stream when the VOB was created has been modified, or whether the dummy audio stream recorded for audio dubbing when the VOB was created has been modified (that is, whether audio dubbing has been done).

In MUX_RATE, a flag indicating whether program_mux_rate in the VOB is 30.24 Mbps or 10.08 Mbps is written. When TV system in M_VOB_STI corresponding to the VOB is “000b (NTSC 60-Hz video system)” or “001b (PAL 50-Hz video system),” “0b” indicating 10.08 Mbps is written in MUX_RATE of FIG. 19. Moreover, when TV system in M_VOB_STI corresponding to the VOB is “010b (extended video format for 60-Hz video system)” or “011b (extended video format for 50-Hz video system),” “0b” indicating 30.24 Mbps is written in MUX_RATE of FIG. 19. A typical example of the extended video format is a next-generation High Definition DVD.

The data structures in FIGS. 17 to 19 are characterized in that M_AVFI (see FIG. 3) includes one or more pieces of M_VOBI, each piece of M_VOBI (see FIG. 17) includes M_VOB_GI, M_VOB_GI (FIG. 18) includes VOB_TY, and the VOB_TY (FIG. 19) includes mux_rate as in FIG. 10.

The mux_rate makes it possible to distinguish between 10.08 Mbps and 30.24 Mbps (not at the object level but at the management information level).

Written in AO_GAP_LOC is whether the corresponding VOB has no audio gap in Audio stream #0, whether a first VOBU in the VOB has an audio gap in Audio stream #0, whether a second VOBU in the VOB has an audio gap in Audio stream #0, and whether a third VOBU in the VOB has an audio gap in Audio stream #0.

Written in A1_GAP_LOC is whether the corresponding VOB has no audio gap in Audio stream #1, whether a first VOBU in the VOB has an audio gap in Audio stream #1, whether a second VOBU in the VOB has an audio gap in Audio stream #1, and whether a third VOBU in the VOB has an audio gap in Audio stream #1.

In SML_FLG, whether conditions for reproducing the corresponding VOB seamlessly from the preceding VOB are satisfied is written. If SML_FLG is “0b,” “0b” is written in SML_EX_FLG. If SML_FLG is “1b,” the following is written in SML_EX_FLG. Specifically, if “Video compression mode” in M_VOB_STI corresponding to the VOB is “000b (MPEG1),” “001b (MPEG2),” or “011b (VC-1),” “0b” is written in SML_EX_FLG.

On the other hand, if “Video compression mode” in M_VOB_STI corresponding to the VOB has “010b (MPEG4-AVC)” written in it, the following is written in SML_EX_FLG.

If SML_EX_FLG=“0b,” it is unknown if the condition SML_EX_FLG=“1b” is satisfied.

If SML_EX_FLG=“1b,” the condition SML_EX_FLG=“1b” is satisfied and one of the following conditions is met.

1) The first picture of the VOB is an IDR (Instantaneous Decoder Refresh: decoder decoding instantaneous refresh) picture and SEQ_END_CODE (sequence end code) is placed at the end of the preceding VOB.

2) The last VOBU of the preceding VOB and the beginning VOBU of the corresponding VOBU belong to the same video sequence continuously. In this case, SEQ_END_CODE is not placed at the end of the preceding VOB. When a first picture of the VOB is not an IDR picture, parameters, including frame number and/or picture sequence count, are prevented from being discontinuous between the preceding VOB and the corresponding VOB.

The apparatus (see FIG. 15) which reproduces an information storage medium using a data structure explained in the embodiment can be configured to use not only SML_FLG but also SML_EX_FLG in determining the operation of seamless reproduction.

### MAIN POINTS OF THE EMBODIMENT

The HD DVD-VR standard has been determined by expanding the DVD-VR standard. Thus, the parts related to Video Object (VOB) are particularly common to the HD DVD-VR standard and the DVD-VR standard. The chief differences between them are the following points:

1. The value of sub_stream_id indicating Linear PCM of Audio Pack differs between DVD-VR and HD DVD-VR.

2. The contents of RDI-PACK have been changed.

3. The scrambling method is CPRM in DVD-VR and AACS in HD DVD-VR.

4. In HD DVD-VR, MPEG4-AVC and VC-1 have been added to Codec usable in Video Pack.

5. The value of program_mux_rate in Pack header is 10.08 Mbps in DVD-VR and 30.24 Mbps maximum in HD DVD-VR.

Accordingly, to convert a stream conforming to the DVD-VR standard to a stream conforming to the HD DVD-VR standard and make a copy at high speed or in the reverse order, the converting processes below have to be carried out in the above items 1 to 3:

1. When Audio is Linear PCM, the value of sub_stream_id is rewritten.

2. The contents of RDI-PCK are rewritten.

3. The cipher of CPRM is decrypted once and then re-encrypted to AACS or the preceding steps are reversed.

However, in items 4 and 5, conversion cannot be done mechanically. Specifically, streams encoded by a Codec not permitted in the DVD-VR standard, such as MPEG4-AVC or VC-1 in item 4, cannot be converted to streams in the DVD-VR standard unless they are re-encoded. Even if they are MPEG2-PS, they are not permitted unless the value of program_mux_rate in Pack Header is 10.08 Mbps in the DVD-VR standard. Thus, even a stream whose program_mux_rate is 30.24 Mbps on a disk complying with the HD DVD-VR standard cannot be converted unless it is re-encoded.

In the latter case, a method of changing the value of program_mux_rate from 30.24 Mbps to 10.08 Mbps mechanically can be considered. However, since it is not written anywhere that the maximum bit rate of the actual MPEG stream is 10.08 Mbps or less, just changing the value of program_mux_rate mechanically acts contrary to the DVD-VR standard.

To avoid this problem, when VOB is recorded onto an HD DVD-VR disk, if the stream is in the range of the DVD-VR standard, program_mux_rate is set to 10.08 Mbps and recording is done. For example, when content is copied from a DVD-VR disk to an HD DVD-VR disk, the value of program_mux_rate is kept unchanged and copied as it is. Moreover, when an HD DVD-VR disk is recorded with an MPEG2 Encoder, if an encode parameter, such as resolution or bit rate, is in the range of the DVD-VR standard, the value of program_mux_rate is set to 10.08 Mbps and recording is done. By doing this, it is possible to determine whether the contents of the HD DVD-VR disk can be copied at high speed to the DVD-VR disk.

Furthermore, in the recording and reproducing apparatus provided with the DVD Drive 28 and HD DVD Drive 26, consider a case where the content recorded onto the HD DVD-VR disk 100 in the HD DVD Drive 26 is copied to the DVD-VR disk 102 in the DVD Drive 28. In this case, the data in the content of the HD DVD-VR disk 100 is read via the HD DVD Drive 26 and is expanded on the SDRAM 22. On the SDRAM 22, the aforementioned stream rewriting processes in items 1 to 3 are carried out and the result is copied to the disk 102 at the copy destination.

However, in the case of a stream satisfying the above conditions in times 4 and 5, it cannot be copied to the DVD-VR disk 102 at high speed without re-encoding. Therefore, if Codec in VOB is MPEG4-AVC or VC-1 (NO in ST20 of FIG. 16) or if MPEG-PS whose program_mux_rate has a value unequal to 10.08 Mbps is detected (NO in ST36 of FIG. 16), the message that high-speed copying cannot be done is displayed, for example, on the screen, thereby inhibiting a high-speed copying process in advance (ST46 of FIG. 16). (Inhibiting a high-speed copying process in advance is important when the copy destination is a write-once R-type disk. The reason is that, if the copying is cancelled because it is known that high-speed copying cannot be done after high-speed copying is started, the part written onto the R disk comes to nothing).

<Summarization>

01. In a video recording and reproducing apparatus capable of reading and writing data conforming to both the DVD-VR standard and HD DVD-VR standard, a content copying method which has the function of copying at high speed onto a disk complying with the DVD-VR standard a VOB which is recorded in MPEG2-PS of contents recorded in the HD DVD-VR standard and whose program_mux_rate in Pack Header has a value of 10.08 Mbps.

02. In a video recording and reproducing apparatus capable of reading and writing data conforming to both the DVD-VR standard and HD DVD-VR standard, a content copying method of making it impossible to copy at high speed onto a disk complying with the DVD-VR standard the content including a VOB recorded in streams other than MPEG2-PS of contents recorded in the HD DVD-VR standard and the content which includes a VOB recorded in MPEG2-PS and whose program_mux_rate in Pack Header has a value of 10.08 Mbps or more.

03. In a video recording and reproducing apparatus capable of reading and writing data conforming to both the DVD-VR standard and HD DVD-VR standard, a content copying method of leaving the value of program_mux_rate in Pack Header at 10.08 Mbps in copying content recorded in the DVD-VR standard onto a disk complying with the HD DVD-VR standard.

This invention is not limited to the above embodiments and, on the basis of available skills in the present or future implementation phase, may be practiced or embodied in still other ways without departing from the spirit or character thereof. For instance, the information storage medium used in the embodiments is not restricted to an optical disk or a hard disk drive and may be a high-capacity flash memory or the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of recording a program stream on an information storage medium capable of recording and reproducing in a first digital recording standard, wherein the program stream obtained by encoding audio-video content according to the first digital recording standard where a maximum transfer rate is limited to a first specific value or less or a second digital recording standard where the maximum transfer rate is limited to a value equal to or smaller than a second specific value larger than the first specific value includes specific information related to at least one of the maximum transfer rate and the second digital recording standard, the recording method comprising:
when the specific information indicates that there is a program stream whose transfer rate used in the encoding is the first specific value or less in the audio-video content recorded in the second digital recording standard, writing the program stream whose transfer rate is the first specific value or less to the information storage medium without re-encoding at a rate higher than the transfer rate used in the original encoding.

2. The recording method according to claim 1, wherein the program stream is recorded in packs,
the specific information is written in the header of a pack,
the first specific value is 10.08 Mbps, and
when the writing is done, the specific information written in the header of the pack is kept indicating 10.08 Mbps.

3. The recording method according to claim 2, wherein the specific information has a transfer rate of the program stream and/or an encode parameter including attribute information on the audio-video content, and
when the transfer rate and the encode parameter comply with the first digital recording standard, if an information storage medium conforming to the second digital recording standard is recorded to, the specific information is set to 10.08 Mbps and the audio-video content is encoded.

4. A method of recording a program stream on an information storage medium capable of recording and reproducing in a first digital recording standard, wherein the program stream obtained by encoding audio-video content according to the first digital recording standard where a maximum transfer rate is limited to a first specific value or less or a second digital recording standard where the maximum transfer rate is limited to a value equal to or smaller than a second specific value larger than the first specific value includes specific information related to at least one of the maximum transfer rate and the second digital recording standard, the recording method comprising:
when the specific information indicates that there is a program stream whose transfer rate used in the encoding is higher than the first specific value in the audio-video content recorded in the second digital recording standard, preventing the program stream whose transfer rate is higher than the first specific value from being written to the information storage medium or, even if object data in the program stream is written, preventing its management information from being written to the information storage medium.

5. An apparatus of recording the program stream on the information storage medium to be used in the recording method as defined in claim 1, said apparatus comprising:
a detection section configured to detect a case where the specific information indicates that there is a program stream whose transfer rate used in the encoding is the first specific value or less in the audio-video content recorded in the second digital recording standard; and
a writing section configured, when the detection section has detected the existence of a program stream whose transfer rate is equal to or lower than the first specific value, to write the program stream whose transfer rate is the first specific value or less to the information storage medium without re-encoding at a rate higher than the transfer rate used in the original encoding.

6. An information storage medium configured to record or reproduce a program stream obtained by encoding audio-video content according to a first digital recording standard where a maximum transfer rate is limited to a first specific value or less or a second digital recording standard where the maximum transfer rate is limited to a value equal to or smaller than a second specific value larger than the first specific value, wherein said program stream includes specific information related to at least one of the maximum transfer rate and the second digital recording standard, said information storage medium comprising:
an object recording area configured to record the program stream of the audio-video content in unit of a pack, and
a management information recording area configured to record management information for managing the audio-video content recorded on the object recording area, wherein
the pack of said program stream includes an area configured to describe one of the first specific value and the second specific value.

7. The information storage medium according to claim 6, wherein said management information includes discrimination information for discriminating between the first digital recording standard and the second digital recording standard.

8. An apparatus of recording the program stream on the information storage medium as defined in claim 6, the recording apparatus comprising:
an object recorder configured to record on said object recording area the program stream of the audio-video content in unit of the pack, and
a management information recorder configured to record on said management information recording area the management information.

9. An apparatus of reproducing the program stream from the information storage medium as defined in claim 6, the reproducing apparatus comprising:
a management information reproducer configured to reproduce the management information from said management information recording area, and
an object reproducer configured to reproduce the audio-video content from said object recording area to provide an audio-video output corresponding to the reproduced content.
